(19) United States
(12) Patent Application Publication
(10) Pub. No.: US 2018/0156484 A1
(43) Pub. Date: Jun. 7, 2018

(54) ENVIRONMENTAL CONDITION MANIPULATION CONTROL

(71) Applicant: Bitfinder, Inc., San Francisco, CA (US)

(72) Inventors: Dae-oong KIM, Seoul (KR); Bosung KIM, San Carlos, CA (US); Ronald RO, Sunnyvale, CA (US); Kevin CHO, Pleasanton, CA (US)

(73) Assignee: Bitfinder, Inc., San Francisco, CA (US)

(21) Appl. No.: 15/367,109

(22) Filed: Dec. 1, 2016

(51) Int. Cl. F24F 11/00; G05B 15/02

(52) U.S. Cl. CPC F24F 11/006; G05B 15/02; F24F 11/0017; F24F 2011/0071; F24F 2011/0061; F24F 2011/0075; F24F 2011/0058; F24F 11/0034

(57) ABSTRACT

According to an example, an apparatus for manipulating an environmental condition may include a processor and a machine-readable storage medium on which is stored instructions. The instructions may cause the processor to receive, via a network, air quality data of an interior of a structure from a management device and generate a command for an appliance based upon the received air quality data, in which the command is to cause the appliance to modify an environmental condition in the structure interior. The instructions may also cause the processor to communicate, via the network, the generated command to at least one of the management device and the appliance.

### CROSS-REFERENCE TO RELATED APPLICATION

This application shares some subject matter with commonly assigned and co-pending U.S. patent application Ser. No. TBD (Attorney Docket No. 1097.002), filed on even date herewith, the disclosure of which is hereby incorporated by reference in its entirety.

### BACKGROUND

The measurement and evaluation of indoor air quality have improved over time. For instance, an increasing number of air quality monitoring devices that have a number of features as well as relatively compact sizes are becoming more readily available. The air quality monitoring devices typically measure the conditions inside of a space, such as a residential, commercial, or industrial environment. The measured conditions may be evaluated to determine whether the conditions are at healthy and/or comfortable levels and modifications to the conditions, such as temperature and humidity, may be made based upon the outcome of the evaluated conditions.

### BRIEF DESCRIPTION OF THE DRAWINGS

Features of the present disclosure are illustrated by way of example and not limited in the following figure(s), in which like numerals indicate like elements, in which:

FIG. 1 shows a simplified block diagram of a system within which an example environmental condition controlling apparatus may be implemented, according to an example;

FIG. 2 shows a block diagram of the example environmental condition controlling apparatus depicted in FIG. 1, according to an example; and

FIGS. 3-7, respectively, depict methods for manipulating an environmental condition in a structure interior, according to examples.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

Disclosed herein are apparatuses for manipulating an environmental condition and methods for implementing the apparatuses. The apparatuses disclosed herein may be cloud-based servers and may receive, via network such as the Internet, air quality data of an interior of a structure from a management device. The management device may include sensors to detect environmental conditions in the structure and/or may otherwise access detected environmental condition information. The management device may communicate the detected environmental condition information (e.g., air quality data) to an apparatus. The apparatuses may generate a command for an appliance based upon the received air quality data, in which the command is to cause the appliance to modify an environmental condition in the structure interior. The apparatuses may also communicate, via the network, the generated command to at least one of the management device and the appliance.

According to examples, the apparatuses may control, via the generated commands, operations of the appliance to vary environmental conditions in the structure. For instance, the apparatuses may determine occupancy information in the structure and may control the environmental conditions based upon the determined occupancy information. In this example, the appliance may be activated in instances in which the structure is determined to be occupied, for instance, to minimize energy consumption of the appliance. As a further example, the apparatuses may monitor a user's interactions with the appliance along with the environmental conditions corresponding to the times at which the user's interactions are monitored. In this example, the user's desired environmental conditions may be determined and the appliance may be operated according to the desired environmental conditions.

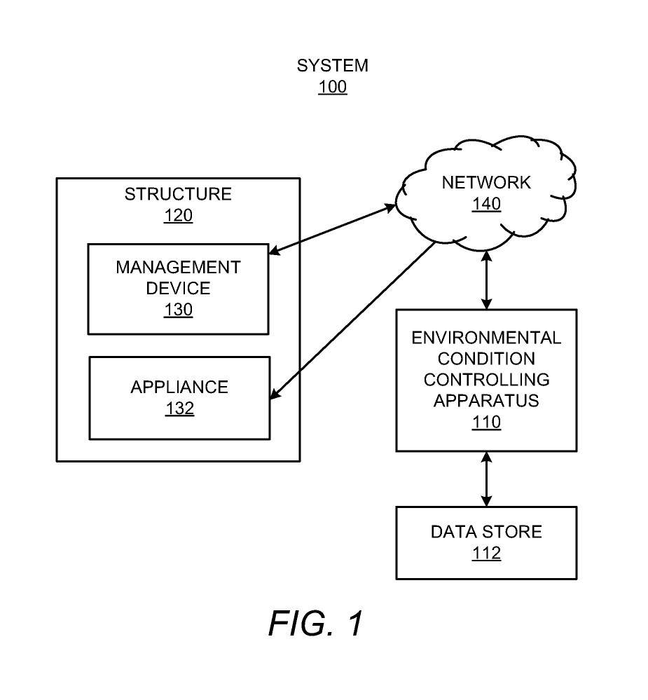

With reference first to FIG. 1, there is shown a simplified block diagram of a system 100 within which an example apparatus 110 may be implemented, according to an example. It should be understood that the system 100 depicted in FIG. 1 may include additional components and that some of the components described herein may be removed and/or modified without departing from the scope of the system 100.

The system 100 is depicted as including an environmental condition controlling apparatus 110 (which is also referenced herein as an apparatus 110), a management device 130, and an environmental condition manipulating appliance 132 (which is also referenced herein as an appliance 132). The apparatus 110 may be a physical machine, such as a computing device on which machine readable instructions that function as a server may be executed. In this regard, the apparatus 110 may be construed as a server computer. The apparatus 110 may store data received from the management device 130 as well as other information in a data store 112.

The management device 130 and the appliance 132 are shown as being positioned within a structure 120. According to examples, the management device 130 may be a standalone device that is to be placed in a location within the structure 120 at which environmental conditions are to be tracked or monitored. In other examples, the management device 130 may be integrated with the appliance 132. The structure 120 may be an indoor structure such as a room in a house, an office in an office building, a gym, a warehouse, or the like. The structure 120 may also be an entire house, office building, etc., or other relatively enclosed space, such as a vehicle, an airplane, or the like.

The management device 130 may include a plurality of sensors (not shown) that may include, for instance, sensors that track or detect various environmental conditions, such as temperature, humidity, carbon dioxide concentration, volatile organic compounds, dust, carbon monoxide, and the like. The sensors may also include, for instance, sensors that detect motion inside the structure 120, e.g., movement by occupants inside the structure 120. The occupants may be humans and/or other types of animals. The management device 130 may thus track one or more environmental conditions, such as temperature, humidity, carbon dioxide concentration, volatile organic compounds, dust concentration, dust levels, and the like, inside the structure 120. The management device 130 may also track other features, such as motion, energy consumption, user interactions with the appliance 132, etc. In addition, the management device 130 may communicate data pertaining to the tracked environmental condition(s) as well as the other features to the apparatus 110 via a network 140. Moreover, the management device 130 may communicate with the appliance 132 via a wired and/or a wireless connection, such as a WiFi connection, a Bluetooth™ connection, a wired connection, or the like.

In other examples, one or more of the sensors may be positioned externally to the management device 130 and the management device 130 may access information related to the detected environmental conditions and/or the detected motion from the externally located sensor(s). For instance, one or more of the sensors may be included in a device that is separate from the management device 130.

The management device 130 may include any of a microphone, a camera, a speaker, a digital display, lights, a user interface, command buttons, etc. Thus, for instance, the management device 130 may receive audible inputs from users and may also output visual and/or auditory signals to users. By way of example, the management device 130 may receive voice commands and/or may output information audibly.

The management device 130 may further include a processor and a memory. The processor may be a semiconductor-based microprocessor, a central processing unit (CPU), an application specific integrated circuit (ASIC), and/or other hardware device. The memory may store, for instance, environmental data collected by the sensors and/or received input. The memory may also store instructions that the processor may execute in collecting, storing, and communicating environmental data as well as in receiving user inputs and outputting information to users. In any regard, the memory may be a Random Access Memory (RAM), an Electrically Erasable Programmable Read-Only Memory (EEPROM), a storage device, an optical disc, or the like.

The management device 130 may further include a network element. The network element may include hardware and/or software to enable the management device 130 to communicate over the network 140. For instance, the network element may include an antenna through which the processor of the management device 130 may wirelessly send and receive data packets.

The appliance 132 may modify one or more of the environmental conditions in the structure 120. For instance, the appliance 132 may be an air conditioning system, a humidifier, a de-humidifier, an air purifier, a heating system, a fan, an actuator for a window, a ventilation system, or the like. In other examples, the appliance 132 may also include other types of devices, such as lights, doors, network connected devices, etc. In some examples, the apparatus 110 may communicate commands for the appliance 132 to the management device 130 and the management device 130 may send instruction signals to the appliance 132 corresponding to the commands. In other examples, the apparatus 110 may communicate commands to the appliance 132 directly. In any of these examples, the apparatus 110 may control the appliance 132 to modify at least one environmental condition in the structure 120.

Although a single appliance 132 has been depicted in FIG. 1, it should be understood that multiple appliances 132 may be included in the structure 120 and that the apparatus 110 may control the multiple appliances 132. In some examples, the appliances 132 may manipulate the same type of environmental condition and in other examples, the appliances 132 may manipulate different types of environmental conditions. The appliances 132 may also be positioned in various locations throughout the structure 120, e.g., in a bedroom, in a kitchen, in a bathroom, etc.

As shown in FIG. 1, the management device 130 may communicate with the apparatus 110 via a network 140, which may be the Internet. The apparatus 110 may thus be a cloud-based server. The apparatus 110 may communicate with a plurality of management devices 130 and may also store received air quality data in the data store 112. The apparatus 110 may communicate with a plurality of management devices 130 and/or appliances 132 located in the same structure 120 and/or in multiple structures 120. The apparatus 110 may thus control environmental conditions at one or multiple locations through control of appliances 132 in those multiple locations.

The apparatus 110 may have stored thereon machine readable instructions that are to analyze air quality data received from the management device 130 to determine, for instance, various environmental and other characteristics of the interior of the structure 120. In some examples, the apparatus 110 may include machine readable instructions that are to cause a processor of the apparatus 110 to generate a command for the appliance 132 based upon the analysis of the air quality data. As discussed in greater detail herein, the apparatus 110 may also generate the command based upon other information, such as occupancy information, energy consumption information, user interaction information, etc. The apparatus 110 may further communicate the generated command to the management device 130 and/or the appliance 132 via the network 140. In instances in which the apparatus 110 communicates the command to the management device 130, the management device 130 may cause the appliance 132 to operate according to the received command.

Generally speaking, the apparatus 110 may implement an environmental condition management operation with respect to the air quality in the structure 120. For instance, the apparatus 110 may determine whether the air quality within the structure 120 is within a desirable range or if the air quality is abnormal, e.g., outside of a predetermined range. In response to a determination that the air quality within the structure 120 is abnormal, the apparatus 110 may output an instruction to cause the appliance 132 to modify an appropriate environmental condition. Various other examples with respect to the management operations that the apparatus 110 may determine are discussed in greater detail hereinbelow.

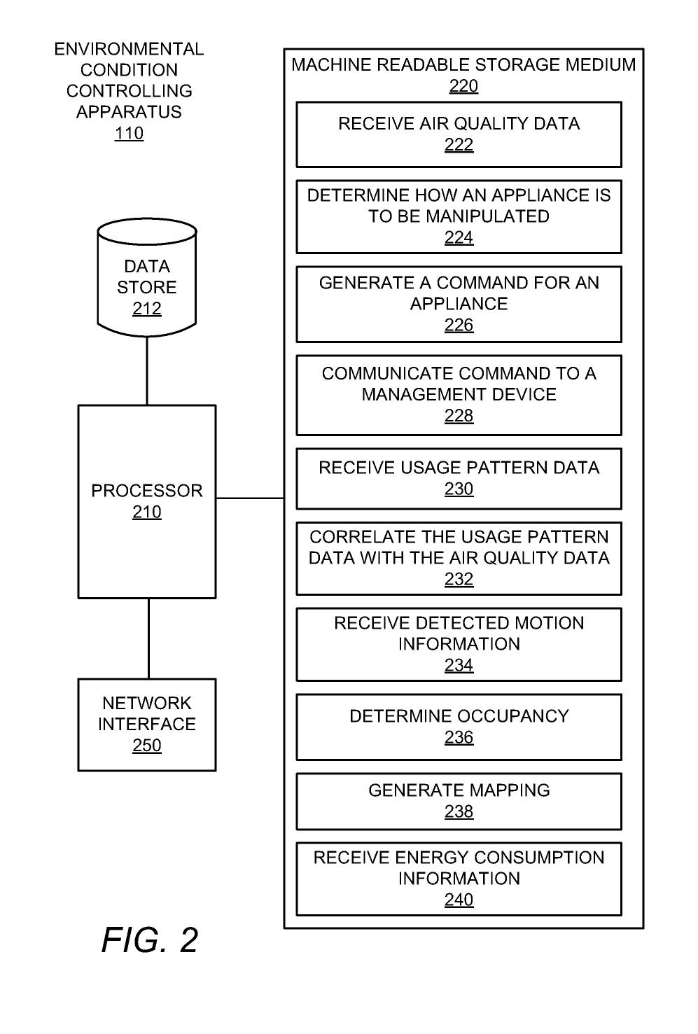

Turning now to FIG. 2, there is shown a block diagram of the environmental condition controlling apparatus 110 depicted in FIG. 1, according to an example. It should be understood that the environmental condition controlling apparatus 110 depicted in FIG. 2 may include additional components and that some of the components described herein may be removed and/or modified without departing from the scope of the environmental condition controlling apparatus 110.

The apparatus 110 may include a processor 210 and a data store 212. The processor 210 may be a semiconductor-based microprocessor, a central processing unit (CPU), an application specific integrated circuit (ASIC), and/or other hardware device. The data store 212 may be a Random Access Memory (RAM), an Electrically Erasable Programmable Read-Only Memory (EEPROM), a storage device, an optical disc, or the like. In addition, the data store 212 may store, for instance, environmental condition data, motion information, etc., received from the management device 130.

The apparatus 110 may also include a machine readable storage medium 220 on which is stored machine readable instructions 222-240 that the processor 210 may execute. More particularly, the processor 210 may fetch, decode, and execute the instructions 222 to receive air quality data from a management device 130, the instructions 224 to determine how an appliance 132 is to be manipulated, the instructions 226 to generate a command for an appliance 132, the instructions 228 to communicate the command to a management device 130, the instructions 230 to receive usage pattern data of the appliance 132, the instructions 232 to correlate the usage pattern data with the air quality data, the instructions 234 to receive detected motion information from the management device 130, the instructions 236 to determine an occupancy of a structure 120 containing the management device 130, the instructions 238 to generate a mapping of the air quality data in the structure 120, and the instructions 140 to receive energy consumption information of the appliance 132. As an alternative or in addition to retrieving and executing instructions, the processor 210 may include one or more electronic circuits that include electronic components for performing the functionalities of the instructions 222-240.

The machine-readable storage medium 220 may be any electronic, magnetic, optical, or other physical storage device that contains or stores executable instructions. Thus, the machine-readable storage medium 220 may be, for example, Random Access Memory (RAM), an Electrically Erasable Programmable Read-Only Memory (EEPROM), a storage device, an optical disc, and the like. The machine-readable storage medium 220 may be a non-transitory machine-readable storage medium, where the term “non-transitory” does not encompass transitory propagating signals.

The processor 210 may generate commands for the appliance 132 and may communicate the commands to the management device 130 and/or the appliance 132 via a network interface 250. The network interface 250 may include hardware and/or software to enable the communication of information. The processor 210 may also receive data from the management device 130 via the network interface 250. Additionally, the communications between the processor 210 and the management device 130, and in certain examples, the appliance 132, may occur over the network 140.

According to an example, the apparatus 110 may include a plurality of processors 210 and/or a processor 210 containing a plurality of cores. In these examples, each the plural processors 210 and/or cores may operate in parallel, i.e., use parallel processing techniques to analyze various different information received from the management device 130. In this regard, the use of multiple processors 210 and/or cores may reduce the amount of time required to receive, analyze, and manage environmental conditions in the structure 120 as well as other data.

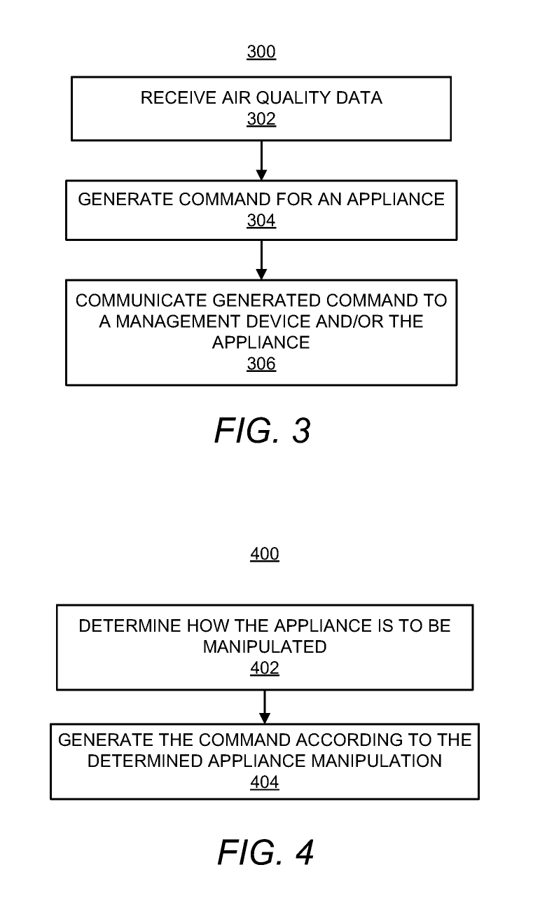

Various manners in which the apparatus 110 may be implemented are described in greater detail below with respect to FIGS. 3-7. Particularly, FIGS. 3-7 respectively show methods 300-700 for manipulating an environmental condition in an interior of a structure 120, according to examples. It should be apparent to those of ordinary skill in the art that the methods 300-700 may represent generalized illustrations and that other operations may be added or existing operations may be removed, modified, or rearranged without departing from the scopes of the methods 300-700.

The descriptions of the methods 300-700 are made with reference to the apparatus 110 illustrated in FIGS. 1 and 2 for purposes of illustration. It should, however, be understood that apparatuses having other configurations may be implemented to perform any of the methods 300-700 without departing from the scopes of the methods 300-700.

With reference first to FIG. 3, at block 302, the processor 210 may execute the instructions 222 to receive air quality data from a management device 130. As discussed above, the management device 130 may track at least one environmental condition, such as temperature, humidity, carbon dioxide concentration, volatile organic compounds, dust concentration, or the like. The management device 130 may track the environmental condition(s) at periodic intervals, for instance, at predetermined times during a day, in response to detected changes in environmental condition, at predetermined intervals in time, or the like.

The management device 130 may also generate air quality data from the tracked environmental condition(s). In some examples, the management device 130 may generate the air quality data by encapsulating the tracked environmental condition(s) into data packets. In other examples, the management device 130 may generate the air quality data by collecting environmental condition data over a period of time, and encapsulating the collected environmental condition into data packets. The management device 130 may further communicate the generated air quality data via a network 140 to the apparatus 110. The processor 210 may thus receive the air quality data via the network 140 and the network interface 250 and may store the received air quality data in the data store 212.

At block 304, the processor 210 may execute the instructions 226 to generate a command for an appliance 132 based upon the received air quality data. Generally speaking, the command is to cause the appliance 132 to be manipulated to modify at least one environmental condition the interior of a structure 120. According to an example, the processor 210 may determine that an environmental condition in the structure 120 is to be modified based upon an analysis of the air quality data. By way of particular example in which the appliance 132 is a heating device, the processor 210 may determine that the appliance 132 is to increase the temperature inside the structure 120 in response to the air quality data indicating that the temperature inside the structure 120 is below a predetermined temperature. In other examples, the processor 210 may determine that an environmental condition in the structure 120 is to be modified, for instance, such that the environmental condition inside the structure 120 is within a predetermined range while minimizing energy consumption of the appliance 132.

At block 306, the processor 210 may communicate the generated command to either or both of the management device 130 and the appliance 132 via the network interface 250 and the network 140. In examples in which the processor 210 communicates the command to the management device 130, the management device 130 may cause the appliance 132 to operate according to the received command. For instance, the management device 130 may generate an instruction signal for the appliance 112 that corresponds to the received command, i.e., the instruction signal is to cause the appliance 132 to carry out the received command. The management device 130 may also communicate the instruction signal to the appliance 132, e.g., through an appliance interface. In examples in which the processor 210 communicates the command to the appliance 132, the appliance 132 may carry out the received command.

According to an example, the processor 210 may also execute the instructions 238 to generate a mapping of the received air quality data. For instance, the processor 210 may generate a mapping of a temperature distribution, air flow characteristics, or the like, in the structure 120 based upon the received air quality data.

Turning now to FIG. 4, there is shown an example method 400, which may be executed in conjunction with the method 300. At block 402, the processor 210 may execute the instructions 224 to determine how an appliance 132 is to be manipulated based upon the received air quality data. For instance, the processor 210 may determine that the received air quality data indicates that an environmental condition inside the structure 120 is outside of a certain range and may determine that the appliance 132 is to be manipulated in a certain manner to bring the environmental condition within the certain range.

In addition or as another example, the processor 210 may determine that the appliance 132 is to be manipulated to cause the environmental condition in the structure 120 to meet a target environmental condition while also minimizing energy consumed by the appliance 132. By way of particular example, the processor 210 may determine that the appliance 132 is to be activated at a particular time in order for the environmental condition to reach the target environmental condition at a certain time in the future. In this regard, the appliance 132 may be activated at a time that may not result in the appliance 132 being activated prematurely, which may result in wasted energy usage.

As a further example, the processor 210 may determine how the appliance is to be manipulated or equivalently, may determine an environmental condition setting for the appliance 132, based upon at least one input. That is, the processor 210 may factor the at least input in determining the environmental condition setting for the appliance 132, in which the at least one input may include at least one of historical air quality data, the current or forecasted weather, seasonality data, etc. For example, the processor 210 may analyze the historical air quality data to find a contextually optimal threshold level for command triggers of the appliance 132. By way of particular example in the processor 210 has historically triggered, e.g., activated, the appliance 132 at a temperature of 20° C. but the environmental condition in the structure 120 is typically around 10° C., the processor 210 may determine that the optimal threshold at which the appliance 132 is to be triggered should be lowered. For instance, the processor 210 may lower the trigger condition to temperature that is lower than 20° C., such as around 15° C. In this regard, the trigger for the appliance 132 may be more contextual and pertinent to the realities of the environmental conditions in the structure 120.

As another example, the processor 210 may determine that an optimal threshold level at which the appliance 132 is to be triggered is to be lowered or heightened based upon predicted environmental conditions external to the structure 120. By way of example, in which the season is winter and the relative humidity level is typically around 10% without any external intervention, it may be difficult to maintain a theoretical optimal level of 35% relative humidity and operating the appliance 132 in an attempt to maintain this relative humidity level may incur a relatively large energy cost. In this example, during the winter season, the processor 210 may lower the humidity threshold level at which the appliance 132 may be triggered to, for instance, about 25% relative humidity to make the appliance trigger more contextual to weather/seasonality.

At block 404, the processor 210 may execute the instructions 226 to generate the command according to the determined appliance 132 manipulation. That is, the processor 210 may generate the command to cause the appliance 132 to be manipulated as determined at block 402. In addition, the processor 210 may communicate the generated command to at least one of the management device 130 and the appliance 132 as discussed above with respect to block 306 in FIG. 3.

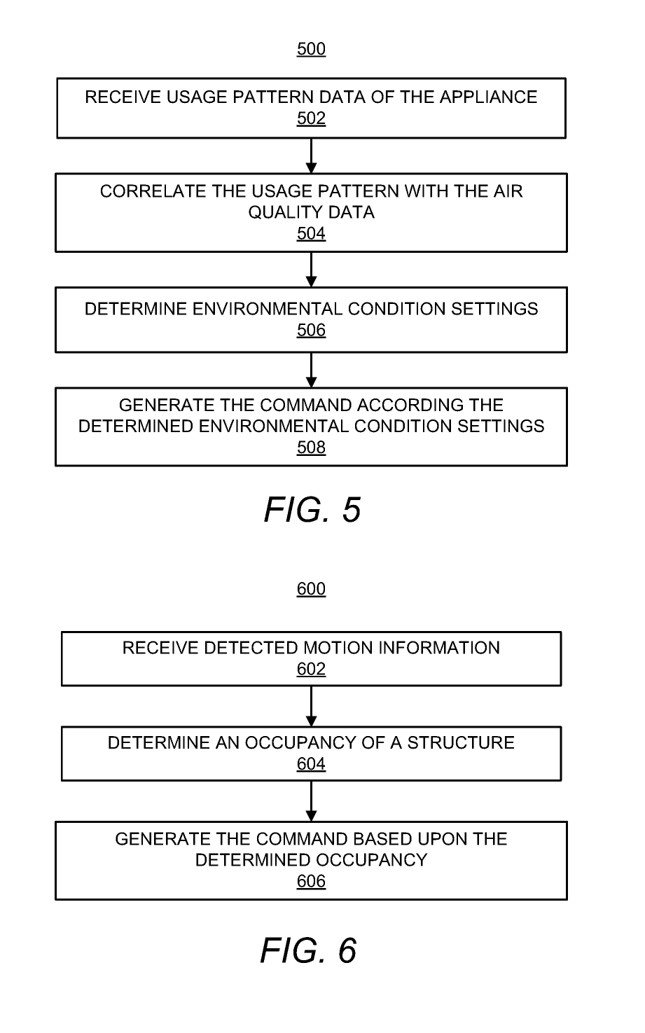

Turning now to FIG. 5, there is shown an example method 500, which may be executed in conjunction with or as an alternative to the methods 300 and 400. At block 502, the processor 210 may execute the instructions 230 to receive usage pattern data of the appliance 132. For instance, the management device 130 may track a user's interactions with the appliance 132 along with the environmental condition(s). The user's interactions may be tracked by tracking, for instance, when a user turns the appliance 132 power on and off or otherwise interacts with the appliance 132 and the environmental condition at the moments at which the user's interactions occur. For instance, the appliance 132 may include components to track this information and may communicate this information to the management device 130.

The management device 130 may also generate the usage pattern of the appliance 132 from the tracked user's interactions with the appliance 132. For instance, the management device 130 may generate the usage pattern to identify the times at which the user interacted with the appliance 132. The management device 130 may also communicate the generated usage pattern to the apparatus 110. At block 504, the processor 210 may execute the instructions 232 to correlate the usage pattern data with the received air quality data. That is, the processor 210 may correlate the environmental conditions at multiple times at which the user interacted with the appliance 132. The correlation may thus denote the existing environmental conditions when a user interacted with the appliance 132. In one regard, the correlation may identify the user's desired environmental condition settings based upon the environmental conditions at the times the user turned off the appliance 132 as that may be an indication that the environmental conditions are at desired levels when the user turned off the appliance 132.

At block 506, the processor 210 may execute the instructions 224 to determine environmental condition settings for the appliance 132 (e.g., how the appliance 132 is to be manipulated) based upon the correlation. By way of particular example, the processor 210 may determine that the appliance 132 is to be activated in order for the environmental conditions in the structure 120 to reach certain levels at a particular time, e.g., at a time when a user would like the environmental conditions to be at certain levels as identified by the correlation.

At block 508, the processor 210 may generate the command for the appliance 132 according to the determined environmental condition settings. In addition, the processor 210 may communicate the generated command to at least one of the management device 130 and the appliance 132 as discussed above with respect to block 306 in FIG. 3.

Turning now to FIG. 6, there is shown an example method 600, which may be executed in conjunction with or as an alternative to the methods 300-500. At block 602, the processor 210 may execute the instructions 234 to receive detected motion information related to detected motion in the structure 120. In some examples, the management device 130 may access the detected motion information through a sensor that is integrated with the management device 130. In other examples, the management device 130 may access the information through receipt of the detected motion information from a sensor located externally to the management device 130. In any regard, the detected motion information may pertain to motion detected inside the structure 120.

At block 604, the processor 210 may execute the instructions 236 to compute an occupancy in the structure 120 based upon the detected motion information and the received air quality data. According to examples, the processor 210 may compute a heuristically correct occupancy in the structure 120 via processing of the detected motion information and the air quality data in a windowed fashion. That is, the processor 210 may compute the occupancy in the structure 120 at multiple windows of time.

The processor 210 may compute the heuristically correct occupancy in the structure 120 through use of an environmental condition such as carbon dioxide level, dust level, or the like, in addition to the detected motion information. The computed occupancy may be relatively more accurate than may be possible through analysis of the detected motion information itself. For instance, the processor 210 may access a lookup table that identifies correlations between carbon dioxide levels and predicted numbers of occupants to determine the number of occupants in the structure 120 based upon a detected carbon dioxide level. In other examples, the processor 210 may determine a predicted number of occupants, e.g., people, inside the structure 120 based upon the CO₂ concentration level detected in the structure 120. That is, the processor 210 may use the average amount of CO₂ that a person typically generates and may divide the detected CO₂ concentration level with the average amount to predict the occupancy in the structure 120. In any of these examples, the processor 210 may make the occupancy determination, for instance, in response to a determination that a motion sensor detected motion in the structure 120. In addition or as another example, the processor 310 may determine that the structure 120 is not occupied even though the detected carbon dioxide level is sufficiently high to indicate that the structure 120 is occupied in response to a determination that a motion sensor did not detect motion in the structure 120.

At block 606, the processor 210 may execute the instructions 224 to generate the command for the appliance 132 according to the computed occupancy. In addition, the processor 210 may communicate the generated command to at least one of the management device 130 and the appliance 132 as discussed above with respect to block 306 in FIG. 3. For instance, the processor 210 may generate a command for the appliance 132 to be turned off in response to the computed occupancy indicating that the structure 120 is vacant. As another example, the processor 210 may generate a command for the appliance 132 to increase activity in response to the computed occupancy indicating that the number of occupants in the structure 120 exceeds a predefined number. According to examples, the processor 210 may track changes in occupancy in the structure 120 and may generate commands as the occupancy is determined to have changed.

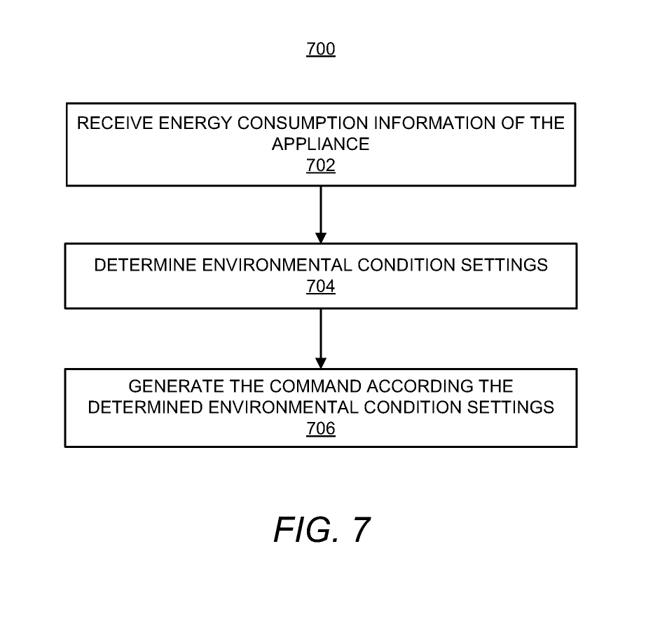

Turning now to FIG. 7, there is shown an example method 700, which may be executed in conjunction with or as an alternative to the methods 300-600. At block 702, the processor 210 may execute the instructions 240 to receive energy consumption information of the appliance 132. The management device 130 may monitor the energy consumption levels of the appliance 132 by, for instance, receiving energy consumption levels from the appliance 132. In other examples, the processor 210 may access the energy consumption levels of the appliance 132 from a sensor or meter that tracks the energy consumption levels. In addition, the management device 130 may communicate the energy consumption information to the apparatus 110 via the network 140.

At block 704, the processor 210 may execute the instructions 224 to determine environmental condition settings for the appliance 132 (e.g., how the appliance 132 is to be manipulated) based upon the received energy consumption information. By way of particular example, the processor 210 may determine that the appliance 132 is to be operated at a reduced operating level in response to a determination that the appliance 132 is consuming energy at a level that is higher than a predefined level.

At block 706, the processor 210 may execute the instructions 226 to generate the command for the appliance 132 based upon the determination. In addition, the processor 210 may communicate the generated command to at least one of the management device 130 and the appliance 132 as discussed above with respect to block 306 in FIG. 3.

Some or all of the operations set forth in the methods 300-700 may be contained as utilities, programs, or subprograms, in any desired computer accessible medium. In addition, the methods 300-700 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus for manipulating an environmental condition, said apparatus comprising:
a processor; and
a machine-readable storage medium on which is stored instructions that are to cause the processor to:
receive, via a network, air quality data of an interior of a structure from a management device;
generate a command for an appliance based upon the received air quality data, wherein the command is to cause the appliance to modify an environmental condition in the structure interior; and
communicate, via the network, the generated command to at least one of the management device and the appliance.

2. The apparatus according to claim 1, wherein to generate the command, the instructions are further to cause the processor to determine how the appliance is to be manipulated to make the environmental condition in the structure interior meet a target environmental condition while minimizing energy consumption by the appliance.

3. The apparatus according to claim 1, wherein to generate the command, the instructions are further to cause the processor to determine how the appliance is to be manipulated based upon at least one input, wherein the at least one input comprises at least one of historical air quality data, weather, and seasonality data.

4. The apparatus according to claim 1, wherein the instructions are further to cause the processor to:
receive usage pattern data of the appliance;
correlate the usage pattern data with the air quality data; and
determine, from the correlation between the usage pattern data and the air quality data, environmental condition settings of the appliance at multiple time periods; and
generate the command according to the determined environmental condition settings.

5. The apparatus according to claim 1, wherein the instructions are further to cause the processor to:
receive detected motion information of the structure interior; and
determine an occupancy in the structure interior from the received detected motion information and the air quality data.

6. The apparatus according to claim 5, wherein the instructions are further to cause the processor to generate the command based upon the determined occupancy.

7. The apparatus according to claim 5, wherein the instructions are further to cause the processor to determine whether the structure is occupied based upon the determined occupancy and to generate the command based upon the determined occupancy, wherein the command includes a command to cause the appliance to be activated in response to a determination that the structure is occupied by at least one person.

8. The apparatus according to claim 1, wherein the instructions are further to cause the processor to generate a mapping of the received air quality data in the structure.

9. A method for manipulating an environmental condition in a structure interior, said method comprising:
receiving, via a network, air quality data of the structure interior from a management device;
generating a command for an appliance based upon the received air quality data, wherein the command is to cause the appliance to modify an environmental condition in the structure interior; and
communicating, via the network, the generated command to at least one of the management device and the appliance.

10. The method according to claim 9, further comprising:
determining how the appliance is to be manipulated to make the environmental condition in the structure interior meet a target environmental condition while minimizing energy consumption by the appliance; and wherein generating the command further comprises generating the command to according to the determined appliance manipulation.

11. The method according to claim 9, further comprising:
determining how the appliance is to be manipulated based upon at least one input, wherein the at least one input comprises at least one of historical air quality data, weather, and seasonality data.

12. The method according to claim 9, further comprising:
receiving usage pattern data of the appliance;
correlating the usage pattern data with the air quality data; and
determining, from the correlation between the usage pattern data and the air quality data, environmental condition settings of the appliance at multiple time periods; and
generating the command according to the determined environmental condition settings.

13. The method according to claim 9, further comprising:
receiving detected motion information of the structure interior;
determining an occupancy in the structure interior from the received detected motion information and the air quality data; and
generating the command based upon the determined occupancy.

14. The method according to claim 13, further comprising:
determining whether the structure is occupied based upon the determined occupancy; and
generating the command based upon the determined occupancy, wherein the command includes a command to cause the appliance to be activated in response to a determination that the structure is occupied by at least one person.

15. The method according to claim 9, further comprising:
generating a mapping of the received air quality data in the structure based upon the received air quality data.

16. A non-transitory machine readable storage medium on which is stored machine readable instructions that when executed by a processor, cause the processor to:
receive, via a network, air quality data of the structure interior from a management device;
generate a command for an appliance based upon the received air quality data, wherein the command is to cause the appliance to modify an environmental condition in the structure interior; and
communicate, via the network, the generated command to at least one of the management device and the appliance.

17. The non-transitory machine readable storage medium according to claim 16, wherein the instructions are further to cause the processor to:
determine how the appliance is to be manipulated to make the environmental condition in the structure interior meet a target environmental condition while minimizing energy consumption by the appliance; and
wherein to generate the command, the instructions are further to cause the processor to generate the command to according to the determined appliance manipulation.

18. The non-transitory machine readable storage medium according to claim 16, wherein the instructions are further to cause the processor to:
receive usage pattern data of the appliance;
correlate the usage pattern data with the air quality data; and
determine, from the correlation between the usage pattern data and the air quality data, environmental condition settings of the appliance at multiple time periods; and
generate the command according to the determined environmental condition settings.

19. The non-transitory machine readable storage medium according to claim 16, wherein the instructions are further to cause the processor to:
receive detected motion information of the structure interior;
determine an occupancy in the structure interior from the received detected motion information and the air quality data; and
generate the command based upon the determined occupancy.

20. The non-transitory machine readable storage medium according to claim 16, wherein the instructions are further to cause the processor to:
determine whether the structure is occupied by at least one person based upon the determined occupancy; and
generate the command based upon the determined occupancy, wherein the command includes a command to cause the appliance to be activated in response to a determination that the structure is occupied by at least one person.
